(19) United States
(12) Patent Application Publication
(10) Pub. No.: US 2006/0087321 A1
(43) Pub. Date: Apr. 27, 2006

(54) Method and apparatus for repairing defective pixel of liquid crystal display

(76) Inventors: Yoshitaka Kawada, Tokyo (JP); Ryuichi Togawa, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/234,188

(22) Filed: Sep. 26, 2005

(30) Foreign Application Priority Data
Sep. 27, 2004 (JP) 2004-279463

(51) Int. Cl. F02P 17/00

(52) U.S. Cl. 324/392; 324/383

(57) ABSTRACT

An defective-pixel repairing method is applicable to a liquid crystal display. A defective pixel of the liquid crystal display is scanned with a pulse laser beam having a repetition frequency of not lower than 1 kHz. The defective pixel is repaired in the state where an air bubble is present at the irradiated position of the pulse laser beam.

### CROSS-REFERENCE TO RELATED APPLICATIONS

This application is based upon and claims the benefit of priority from prior Japanese Patent Application No. 2004-279463, filed Sep. 27, 2004, the entire contents of which are incorporated herein by reference.

### BACKGROUND OF THE INVENTION

1. Field of the Invention

The present invention relates to a method and apparatus for repairing a defective pixel of a liquid crystal display.

2. Description of the Related Art

In general, an active matrix type liquid crystal display comprises two glass substrates that face each other, with a liquid crystal interposed therebetween. One of the two glass substrates is referred to as a TFT substrate, and a large number of signal lines and gate lines arranged in a matrix pattern are provided on the inner surface of the TFT substrate. Pixel electrodes, each having a size of tens of μm to hundreds of μm, are formed in the areas surrounded by the signal and gate lines. TFTs are arranged at the intersections between the signal lines and the gate lines.

The other one of the two glass substrates is referred to as a color filter substrate. The color filter substrates have color filters on the inner surface thereof. Each color filter is made up of a coloring layer and a protective layer.

The two glass substrates have alignment layers, respectively. The alignment layers are made of polyimide (PI) and are in contact with a liquid crystal. Polarizing plates are attached to the outer surfaces of the glass substrates, respectively.

Since the recent liquid crystal displays have wide screens and high resolutions, how to prevent defects is important in the manufacturing process of liquid crystal displays. Among the defects, a pixel whose TFT does not function and a pixel whose liquid crystal cannot be driven, are defects that have to be reduced by any means. If such defects are caused, the liquid crystal material does intercept the backlight, and a related defective pixel is regarded as a “bright defect.”

Since the “bright defects” significantly lower the display performance of the liquid crystal displays, the reduction of the “bright defects” is tried by choosing desirable design values and properly determining the conditions under which the manufacturing process is carried out. However, reducing the bright defects by this approach is restricted, and the bright defects cannot be completely eliminated.

Under the circumstances, liquid crystal displays are manufactured first, and then the manufactured liquid crystal displays are checked to see whether “bright defects” are present. If “bright defects” are found, they are repaired one by one.

As a method for repairing defective pixels of a liquid crystal display, the amount of light transmitted through the defective pixels is reduced, thereby making the “bright defects” less conspicuous (see Jpn. Pat. Appln. KOKAI Publication No. 7-225381).

FIG. 9A is a plan view of defective pixel G which is repaired, and FIG. 9B is a sectional view of the defective pixel G which is repaired.

As shown in FIG. 9A, defective pixel G is irradiated with pulse laser beam L which is moved in the directions indicated by arrows A. The irradiation of pulse laser beam L generates an air bubble in liquid crystal Q. The irradiation of pulse laser beam L melts and evaporates alignment films I, so that fine particles of polyimide are also generated.

The fine particles generated by the irradiation of pulse laser beam L are deposited on the inner surface of defective pixel G, and the alignment characteristic which alignment films I have on liquid crystal material Q is degraded. As a result, the amount of light passing through the defective pixel G decreases, making the “bright defect” less conspicuous.

As FIG. 9B shows, air bubble P generated by the irradiation of pulse laser beam L stays in the defective pixel G because of the steps provided by the signal and gate lines. Since air bubble P in this state permits the fine particles to move freely, they can be deposited on the inner surface of the defective pixel G (i.e., on alignment films I) with high efficiency.

In recent years, liquid crystal displays for which the flattening process has been carried out have been developed. In such flattened liquid crystal displays, a thick insulating film is formed over the signal lines and gate lines, and the pixel electrodes are provided on this insulating film. With this structure, the liquid crystal displays have few elements protruding from the TFT substrate toward the liquid crystal.

Since the flattening process helps increase the pixel areas, the transmission efficiency of backlight is improved. This being so, where a liquid crystal display subjected to the flattening process and a liquid crystal display not subjected to the flattening process have the same resolution, the former provides a more increased brightness. Where the liquid crystal display subjected to the flattening process and the liquid crystal display not subjected to the flattening process have the same level of brightness, the former provides a higher resolution. Where the liquid crystal display subjected to the flattening process and the liquid crystal display not subjected to the flattening process have the same level of brightness and provides the same resolution, the former consumes a smaller amount of power than the latter. Because of these advantages, the flattening process is carried out for many of the recent liquid crystal displays.

As described above, the flattening process reduces the number of elements protruding from the TFT substrate toward the liquid crystal. As a result, it is hard to permit an air bubble generated in the liquid crystal to remain in a defective pixel.

It may happen that no air bubble exists at the laser beam irradiated position and that generated fine particles are not successfully deposited on the inner surface of the defective pixel, when a defective pixel is irradiated with a laser beam. In this case, the amount of light transmitted through the defective pixel is not significantly reduced. Even after the defective pixel is repaired, it may be regarded as a white or whitish point.

### BRIEF SUMMARY OF THE INVENTION

The present invention may provide a defective-pixel repairing method and a defective-pixel repairing apparatus which are applicable to a liquid crystal display and which can easily and reliably repair a defective pixel of the liquid crystal display.

According to one aspect of the present invention, a defective-pixel repairing method applicable to a liquid crystal display is provided. The defective-pixel repairing method is configured to irradiate a defective pixel of the liquid crystal display with a pulse laser beam having a repetition frequency of not lower than 1 kHz, and to repair the defective pixel in the state where an air bubble is present at the irradiated position of the pulse laser beam.

According to another aspect of the present invention, a defective-pixel repairing apparatus applicable to a liquid crystal display is provided. The defective-pixel repairing apparatus is configured to scan a defective pixel of the liquid crystal display with a pulse laser beam emitted from a laser oscillator. The apparatus is provided with a control section that moves the liquid crystal display and the pulse laser beam relative to each other when the defective pixel is scanned with the pulse laser beam. The laser output the laser oscillator provides per pulse is substantially constant where the repetition frequency of the pulse laser beam is not lower than 1 kHz.

According to still another aspect of the present invention, a defective-pixel repairing apparatus applicable to a liquid crystal display is provided. The defective-pixel repairing apparatus comprises: a stage on which the liquid crystal display is provided; a laser emitting section including a pulse laser oscillator and configured to irradiate a defective pixel of the liquid crystal display with a pulse laser beam emitted from the pulse laser oscillator; and a control section configured to move the liquid crystal display and the pulse laser beam relative to each other when the defective pixel is scanned with the pulse laser beam, the laser output which the laser oscillator provides per pulse is substantially constant where the repetition frequency of the pulse laser beam is not lower than 1 kHz.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of a liquid crystal display according to a first embodiment of the present invention.

FIG. 2 is a schematic diagram illustrating a defective-pixel repairing apparatus applicable to the liquid crystal display according to a first embodiment.

FIG. 3 is a graph showing frequency characteristics of a laser oscillator, which is employed in the defective-pixel repairing apparatus according to a first embodiment.

FIG. 4A is a schematic diagram illustrating a path along which raster scanning is performed according to a first embodiment.

FIG. 4B is an explanatory diagram illustrating an overlapping rate of laser spots according to the first embodiment.

FIG. 5 is a schematic diagram of a laser oscillator according to a second embodiment of the present invention.

FIG. 6 is a schematic diagram of a laser oscillator according to a third embodiment of the present invention.

FIG. 7 is a schematic diagram of a defective-pixel repairing apparatus applicable to a liquid crystal display according to a fourth embodiment of the present invention.

FIG. 8 is a schematic diagram of a defective-pixel repairing apparatus applicable to a liquid crystal display according to a fifth embodiment of the present invention.

FIG. 9A is a plan view of a defective pixel which is being repaired.

FIG. 9B is a sectional view of the defective pixel which is being repaired.

### DETAILED DESCRIPTION OF THE INVENTION

A first to fifth embodiments of the present invention will now be described in detail with reference to the accompanying drawings.

### A FIRST EMBODIMENT

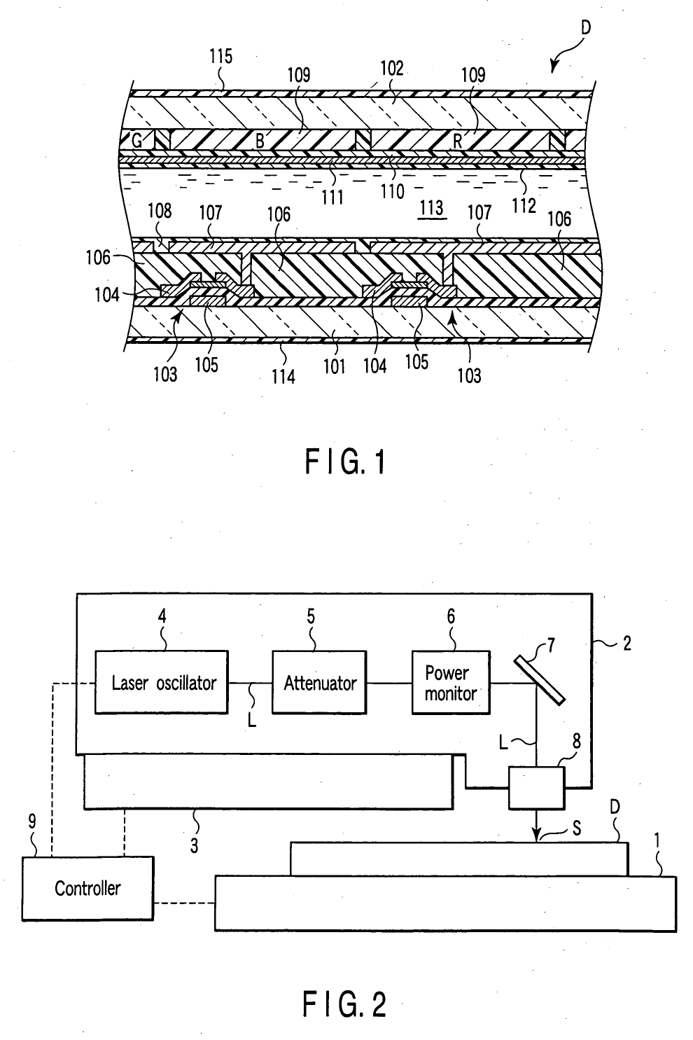

The first embodiment of the present invention will now be described with reference to FIGS. 1-4.

FIG. 1 is a sectional view of a liquid crystal display according to the first embodiment of the present invention.

As shown in FIG. 1, the liquid crystal display D is a display for which the so-called flattening process has been carried out, and comprises two glass substrates 101 and 102 facing each other.

One (101) of the two glass substrates 101 and 102 is referred to as a TFT substrate, and a plurality of TFTs 103 arranged in a matrix pattern are formed on the inner surface of the TFT substrate 101. Gate lines 105 for driving the TFTs 103, and signal lines 104 for electrically charging or discharging the pixel electrodes 107, are arranged on the glass substrate 101 in a matrix pattern. The resultant structure is overlaid with a thick insulating film 106 so as to cover the signal lines 104 and the gate lines 105.

Pixel electrodes 107, which are electrically charged or discharged by the TFTs 103, are formed in a matrix pattern on the thick insulating film 106. The pixel electrodes 107 are overlaid with an alignment film 108 formed of polyimide.

The other one (102) of the two glass substrates 101 and 102 is referred to as a color filter substrate. The color filter substrate 102 has color filters 109 on the inner surface thereof. Each color filter 109 is one of R (red), G (green) or B (blue) and located at the position corresponding to one of the pixel electrodes 107.

The color filters 109 are overlaid with a protective film 110 and an indium tin oxide (ITO) film 111 in the order named. The indium tin oxide film 111 is overlaid with an alignment film 112 formed of polyimide.

A liquid crystal 113 is sealed between the glass substrates 101 and 102. Polarizing films 114 and 115 are attached to the out surfaces of the glass substrates 101 and 102, respectively.

The liquid crystal display D of the above configuration allows or prevents light transmission in accordance with the directions in which the liquid crystal molecules driven by the TFTs 103 are aligned. However, the pixels of the liquid crystal display D may include defective pixel G which looks bright irrespective of whether the TFTs 12 are driven or not. The method which the present invention employs to repair defective pixel G decreases the amount of light transmitted through defective pixel G, thereby making defective pixel G less conspicuous.

A defective-pixel repairing apparatus applicable to a liquid crystal display according to the first embodiment will now be described, referring to FIGS. 2-4.

FIG. 2 is a schematic diagram illustrating the defective-pixel repairing apparatus according to the first embodiment.

As shown in FIG. 2, the defective-pixel repairing apparatus comprises: a first stage 1; a laser emitting section 2 arranged above the first stage 1; and a controller 9. The liquid crystal display D is held on the first stage 1.

The laser emitting section 2 is supported on a second stage 3 and contains a laser oscillator 4, an attenuator 5, a power monitor 6, a reflecting mirror 7 and a condensing lens 8.

The attenuator 5, the power monitor 6 and the reflecting mirror 4 are arranged on the optical path along which pulse laser beam L emitted from the laser oscillator 4 travels, as shown in FIG. 2. The condensing lens 8 is arranged perpendicularly on the optical path along which pulse laser beam L reflected by the reflecting mirror 7 travels.

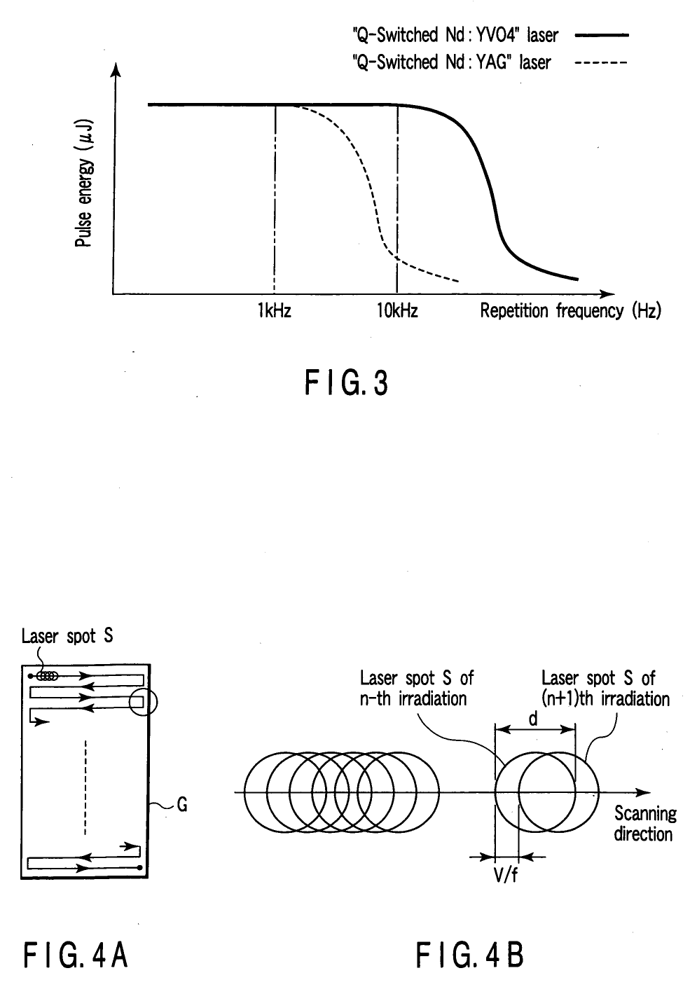

The laser oscillator 4 is a Q-Switched Nd:YVO4 laser oscillator. The reason why the Q-Switched Nd:YVO4 laser oscillator is used in the first embodiment is that, as indicated by the solid line in FIG. 3, the pulse energy (laser output) hardly varies and maintains a constant value even where the repetition frequency is higher than 1 kHz (and is lower than 10 kHz or so). As indicated by the broken line in FIG. 3, the pulse energy (laser output) of a Q-Switched Nd:YAG laser oscillator used in the conventional art drops sharply where the repetition frequency is higher than 1 kHz.

The attenuator 5 attenuates the energy of pulse laser beam L emitted from the laser oscillator 4. The power monitor 6 detects the energy of pulse laser beam L output from the attenuator 5. The reflecting mirror 7 reflects pulse laser beam L output from the attenuator 5 substantially at right angles so that the reflected pulse laser beam is guided toward the condensing lens 8. By this condensing lens 8, the pulse laser beam L reflected by the reflecting mirror 7 is condensed in such a manner that the condensed laser beam forms a spot of 1 μm to 3 μm. In this condensed state, the laser beam falls on defective pixel G.

The controller 9 described above is connected to the first stage 1, second stage 3 and laser oscillator 4. The controller 9 has: the function of horizontally moving the first stage 1 so that defective pixel G of the liquid crystal display D comes to the position just under the condensing lens 8; the function of horizontally moving the second stage 3 so that defective pixel G can be raster-scanned with laser spot S; the function of controlling the repetition frequency of the pulse laser beam L; and the function of synchronizing the repetition frequency and scanning velocity of pulse laser beam L.

FIG. 4A is a schematic diagram illustrating a path along which raster scanning is performed according to the first embodiment. FIG. 4B is an explanatory diagram illustrating an overlapping rate of laser spots according to the first embodiment.

In FIGS. 4A and 4B, “d” denotes the diameter of laser spot S, “v” denotes the scanning velocity of pulse laser beam L, and “f” denotes the repetition frequency of pulse laser beam L. In this case, the controller 9 controls either repetition frequency f or scanning velocity v in such a manner that overlapping rate “a” of laser spots S becomes constant.

In the first embodiment, the scanning velocity V is controlled by adjusting the speed at which the second stage 3 is moved (i.e., the speed at which pulse laser beam L is moved). Needless to say, this control in no way restricts the present invention. For example, the scanning velocity may be controlled by adjusting the speed at which the first stage 1 is moved (i.e., the speed at which the liquid crystal display D is moved).

The overlapping rate “a” of laser spots S is represented by:
a=1−(v/f·d)

As can bee seen from this formula, when the scanning velocity v decreases, the controller 9 decreases the repetition frequency f so as to maintain the overlapping rate “a” of laser spots S.

A description will now be given as to how the defective-pixel repairing method of the above configuration operates.

After the liquid crystal display D is held on the first stage 1, the first stage 1 is moved horizontally until defective pixel G of liquid crystal display D comes to the position just under the condensing lens 8.

Then, the laser oscillator 4 emits pulse laser beam L at repetition frequency f. This repetition frequency f is controlled such that it is not lower than 1 kHz and permits overlapping rate “a” of laser spots S to be constant.

Pulse laser beam L emitted from the laser oscillator 4 passes via the attenuator 5, power monitor 6 and reflecting mirror 7 and is then guided onto the condensing lens 8. This condensing lens 8 condenses pulse laser L to a predetermined diameter, and the condensed pulse laser beam L falls on defective pixel G of liquid crystal display D.

Simultaneous with this, the second stage 3 is moved horizontally, and defective pixel G is raster-scanned with laser spot S, as shown in FIG. 4A. As a result, substantially the entire area of defective pixel G is irradiated with pulse laser beam L.

When defective pixel G is irradiated with pulse laser beam L, the laser energy generates an air bubble in the liquid crystal 113. This air bubble moves away from the irradiated position of pulse laser beam L in 20 ms to 100 ms (this phenomenon is confirmed in the art).

To prevent the phenomenon, the first embodiment controls the repetition frequency of pulse laser beam to be not lower than 1 kHz. By controlling the repetition frequency in this manner, pulse laser beam L is emitted at the intervals of 20 ms or shorter. In other words, each pulse laser beam L is emitted when the air bubble generated by the pulse laser beams L, which have been emitted already, is still present (i.e., within 20 ms of the emission time of the last pulse laser beam). Hence, pulse laser beam L is emitted to defective pixel G when the air bubble is still present in the liquid crystal 113.

Where pulse laser beam L is emitted when an air bubble is present in the liquid crystal 113, most of the laser energy is absorbed in the alignment films 108 and 112. As a result, the components of the alignment films 108 and 112 melt and evaporate. The evaporated components of the alignment films 108 and 112 are cooled, generating fine particles. After drifting in the air bubble, the fine particles are deposited over the alignment films 108 and 112 as if the alignment films 108 and 109 were covered with gravel. This reduces the alignment characteristic which the alignment films 108 and 112 have on the liquid crystal 113, and the amount of light passing through defective pixel G decreases. As a result, defective pixel G darkens and becomes less conspicuous.

The defective pixel-repairing apparatus described above employs a Q-Switched Nd:YVO4 laser as the laser oscillator 4, and defective pixel G is irradiated with pulse laser beam L at a repetition frequency of not lower than 1 kHz.

Therefore, pulse laser beam L is emitted before the air bubble in the liquid crystal 113 moves away from the irradiated position. Thus, an air bubble is always present whenever defective pixel G is irradiated with pulse laser beam L.

The fine particles which the alignment films 108 and 112 generate upon irradiation of pulse laser beam L are efficiently deposited on the position corresponding to defective pixel G. Hence, defective pixel G of liquid crystal display D can be repaired reliably.

Where a TFT substrate has a flat inner surface as in the case of the present invention, an air bubble moves in a short time after it is generated. It is therefore very advantageous to emit a laser beam at a high repetition frequency of not lower than 1 kHz.

The pulse energy does not significantly vary unless the repetition frequency is not lower than 1 kHz. Therefore, even if the repetition frequency f decreases when scanning velocity v decreases at the turning points of the scanning path, defective pixel G can be repaired reliably.

In addition, since the present invention only requires using a Q-Switched Nd:YVO4 laser as the laser oscillator 4, the advantages described above can be easily obtained. Furthermore, the present invention is applicable to conventional apparatuses.

### A SECOND EMBODIMENT

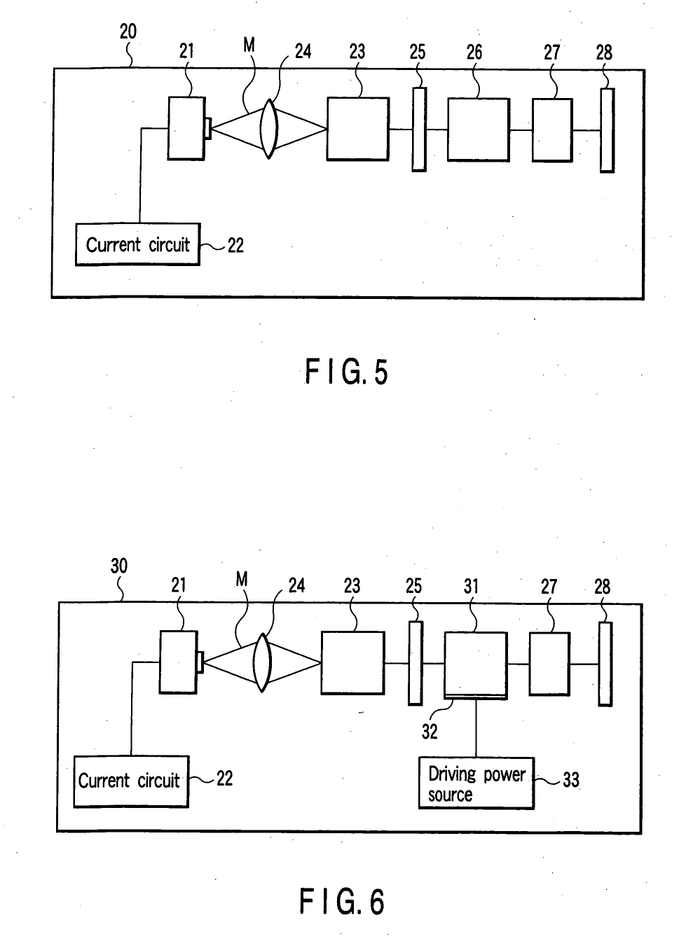

The second embodiment of the present invention will now be described with reference to FIG. 5. For the sake of simplicity, no description will be given of those structures and operations which are similar to those of the first embodiment.

FIG. 5 is a schematic diagram showing a laser oscillator according to the second embodiment of the present invention.

As shown in FIG. 5, the laser oscillator 20 of the second embodiment is provided with a laser diode 21 serving as an excitation source, and a current circuit 22 configured to supply a current to the laser diode 21.

Based on a command supplied from the controller 9, the current circuit 22 supplies the laser diode 21 with a current corresponding to repetition frequency f. The power of the excitation light M emitted by the laser diode 21 is therefore controlled in such a manner that the output power of pulse laser beam L is substantially constant even if repetition frequency f increases.

In the second embodiment, if repetition frequency f of pulse laser beam L increases, the power of the excitation light M emitted by the laser diode 21 is controlled in such a manner as to follow the increase in repetition frequency f. It is therefore possible to provide a wide frequency range in which the pulse energy does not decrease.

In the second embodiment, the current supplied to the laser diode 21 is controlled. Instead of this control, the energy of the excitation beam M emitted from the laser diode 21 may be adjusted by use of the attenuator 23.

In FIG. 5, numeral 24 denotes a condensing lens for condensing excitation beam M emitted from the laser diode 21, numeral 25 denotes a mirror that allows transmission of only light that has the same wavelength as excitation beam M, numeral 26 denotes a Q switch configured to switch the Q value of the laser oscillator 20 from one to another; numeral 27 denotes a laser rod doped with Nd (laser material); and numeral 28 denotes an output mirror configured to output a generated pulse laser beam from the laser oscillator 20.

### A THIRD EMBODIMENT

The third embodiment of the present invention will now be described with reference to FIG. 6. For the sake of simplicity, no description will be given of those structures and operations which are similar to those of the first and second embodiments.

FIG. 6 is a schematic diagram showing a laser oscillator according to the third embodiment of the present invention.

As shown in FIG. 6, the laser oscillator 30 of the third embodiment is provided with an AOQ switch 31, a transducer 32 configured to apply RF power to the AOQ switch 31, and a driving power source 33 configured to apply a voltage to the transducer 32.

Based on a command supplied from the controller 9, the driving power source 33 applies the transducer 32 with a voltage corresponding to repetition frequency f. The RF power applied from the transducer 32 to the AOQ switch 31 is controlled in such a manner that the output power of pulse laser beam L is substantially constant even if repetition frequency f increases.

In the third embodiment, if repetition frequency f of pulse laser beam L increases, the RF power applied to AOQ switch 31 is controlled in accordance with repetition frequency f. It is therefore possible to provide a wide frequency range in which the pulse energy does not decrease.

### A FOURTH EMBODIMENT

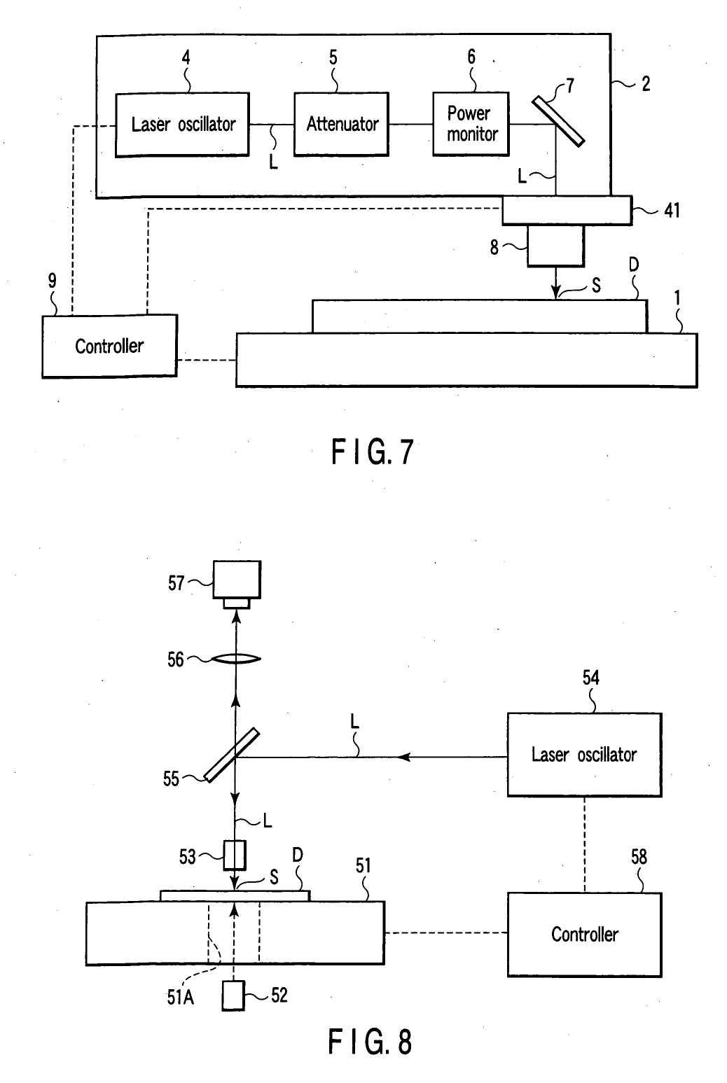

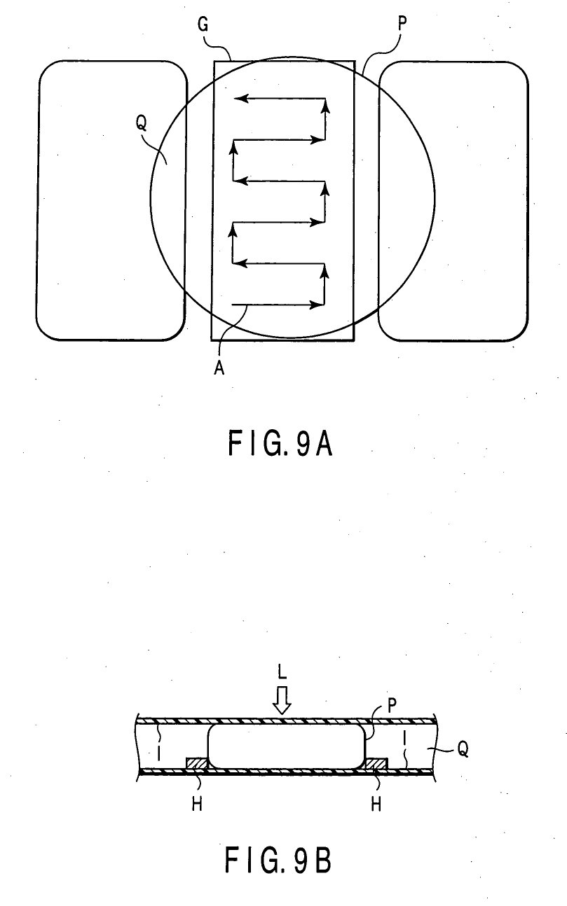

The fourth embodiment of the present invention will now be described with reference to FIG. 7. For the sake of simplicity, no description will be given of those structures and operations which are similar to those of the first to third embodiments.

FIG. 7 is a diagram of a defective-pixel repairing apparatus applicable to a liquid crystal display according to the fourth embodiment of the present invention.

As shown in FIG. 7, the defective-pixel repairing apparatus of the fourth embodiment comprises a third stage 41 configured to horizontally moving the condensing lens 8. Based on a command supplied from the controller 9, the third stage 41 drives the condensing lens 8 so as to move pulse laser beam L emitted from the condensing lens 8.

With this structure, defective pixel G of liquid crystal display D is scanned with pulse laser beam L output from the condensing lens 8. In the fourth embodiment, defective pixel G is scanned by moving pulse laser beam L, not liquid crystal display D. In other words, the present invention is applicable even to this type of defect-pixel repairing apparatus.

### A FIFTH EMBODIMENT

The fifth embodiment of the present invention will now be describe with reference to FIG. 8. For the sake of simplicity, no description will be given of those structures and operations which are similar to those of the first to fourth embodiments.

FIG. 8 is a schematic diagram showing a defective-pixel repairing apparatus applicable to a liquid crystal display according to the fifth embodiment of the present invention.

As shown in FIG. 8, the defective-pixel repairing apparatus of the fifth embodiment comprises a stage 51 on which liquid crystal display D is held. The stage 51 has a through hole 51A located substantially in the center thereof and extending in the vertical direction. A transmission light source 52 is provided under the stage 51 and located at the position corresponding to the through hole 51A. The light emitted from the transmission light source 52 travels through the through hole 51A and illuminates the liquid crystal display D held on the stage 51.

A condensing lens 53 is provided above the stage 51 and located at the position corresponding to the through hole 51A. The condensing lens 53 is arranged with its axis kept vertical. Pulse laser beam L emitted from the laser oscillator 54 and reflected by a half mirror 55 falls on the condensing lens 53, and then falls on defective pixel G of liquid crystal display D after being condensed by the condensing lens 53.

Lens 56 is provided above the half mirror 55, and a CCD camera 57 is provided above lens 56. The light emitted from the transmission light source 52 passes through defective pixel G of liquid crystal display D, then travels through the condensing lens 53, half mirror 55 and lens 56 in the order named, and is then incident on the CCD camera 57.

A controller 58 is connected to the laser oscillator 54 and the stage 51. This controller 58 has: the function of controlling the repetition frequency of pulse laser beam L emitted from the laser oscillator 54; and the function of moving the stage 51 so that defective pixel G of liquid crystal display D comes to the position just under the condensing lens 53. The present invention is applicable even to this type of defect-pixel repairing apparatus.

The present invention is not limited to the embodiments described above, and can be modified in various ways without departing from the spirit and scope of the invention. Moreover, the structural elements of the above embodiments can be selectively combined to make various inventions. For example, some structural elements may be deleted from each embodiment, and structural elements of different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A defective-pixel repairing method applicable to a liquid crystal display, wherein a defective pixel of the liquid crystal display is scanned with a pulse laser beam having a repetition frequency of not lower than 1 kHz, and the defective pixel is repaired in a state where an air bubble is present at an irradiated position of the pulse laser beam.

2. The method according to claim 1, wherein the pulse laser beam is controlled such that a laser output corresponding to one pulse is kept substantially at a predetermined value.

3. The method according to claim 2, wherein the pulse laser beam is emitted from a Q-Switched Nd:YVO4 laser oscillator.

4. The method according to claim 2, wherein the pulse laser beam is emitted from a laser oscillator using a laser diode as an excitation source, and power of excitation light emitted from the laser diode is controlled in accordance with the repetition frequency of the pulse laser beam.

5. The method according to claim 2, wherein the pulse laser beam is subject to Q switching by an AOQ switch, and RF power applied to the AOQ switch is controlled in accordance with the repetition frequency of the pulse laser beam.

6. The method according to claim 2, wherein the pulse laser forms a laser spot having a predetermined diameter when the defective pixel is scanned with the pulse laser beam.

7. The method according to claim 6, wherein the repetition frequency and scanning velocity of the pulse laser beam are controlled such that an overlapping rate of laser spots formed by the pulse laser beams is substantially constant.

8. The method according to claim 7, wherein the overlapping rate of the laser spots formed by the pulse laser beams is defined by:
a=1−(v/f·d)
where “a” denotes the overlapping rate, “d” denotes a diameter of the laser spots of the pulse laser beam, “v” denotes a scanning velocity of the pulse laser beam, and “f” denotes a repetition frequency of the pulse laser beam.

9. The method according to claim 7, wherein the repetition frequency of the pulse laser beam is controlled in accordance with the scanning velocity of the pulse laser beam.

10. The method according to claim 7, wherein the scanning velocity of the pulse laser beam is controlled in accordance with the repletion frequency of the pulse laser beam.

11. A defective-pixel repairing apparatus applicable to a liquid crystal display and configured to scan a defective pixel of the liquid crystal display with a pulse laser beam emitted from a laser oscillator, said apparatus comprising:
a control section that moves the liquid crystal display and the pulse laser beam relative to each other when the defective pixel is scanned with the pulse laser beam,
a laser output which the laser oscillator provides per pulse is substantially constant where the repetition frequency of the pulse laser beam is not lower than 1 kHz.

12. The apparatus according to claim 11, wherein the laser oscillator is a Q-Switched Nd:YVO4 laser oscillator.

13. The apparatus according to claim 11, wherein the laser oscillator includes a laser diode configured to oscillate excitation light,
power of the excitation light provided by the laser diode is controlled by adjusting a current to the laser diode in accordance with the repetition frequency of the pulse laser beam.

14. The apparatus according to claim 11, wherein the laser oscillator includes:
an AOQ switch; and
a transducer configured to apply RF power to the AOQ switch,
the RF power applied to the AOQ switch is controlled by adjusting a voltage to the transducer in accordance with the repetition frequency of the pulse laser beam.

15. A defective-pixel repairing apparatus applicable to a liquid crystal display, comprising:
a stage on which the liquid crystal display is provided;
a laser emitting section including a pulse laser oscillator and configured to irradiate a defective pixel of the liquid crystal display with a pulse laser beam emitted from the pulse laser oscillator; and
a control section configured to move the liquid crystal display and the pulse laser beam relative to each other when the defective pixel is scanned with the pulse laser beam,
a laser output which the laser oscillator provides per pulse is substantially constant where the repetition frequency of the pulse laser is not lower than 1 kHz.

16. The apparatus according to claim 15, wherein the laser oscillator is a Q-Switched Nd:YVO4 laser oscillator.

17. The apparatus according to claim 15, wherein the pulse laser beam forms a laser spot having a predetermined diameter when the defective pixel is scanned with the pulse laser beam.

18. The apparatus according to claim 17, wherein an overlapping rate of the laser spots formed by the pulse laser beams is defined by:
a=1−(v/f·d)
where “a” denotes the overlapping rate, “d” denotes a diameter of the laser spots of the pulse laser beam, “v” denotes a scanning velocity of the pulse laser beam, and “f” denotes a repetition frequency of the pulse laser beam.

19. The apparatus according to claim 18, wherein the scanning velocity of the pulse laser beam is controlled in accordance with the repletion frequency of the pulse laser beam, such that the overlapping rate is substantially constant when the defective pixel is scanned with the pulse laser beam.

20. The apparatus according to claim 18, wherein the repetition frequency of the pulse laser beam is controlled in accordance with the scanning velocity of the pulse laser beam, such that the overlapping rate is substantially constant when the defective pixel is scanned with the pulse laser beam.
